(19) United States
(12) Patent Application Publication
(10) Pub. No.: US 2024/0401715 A1
(43) Pub. Date: Dec. 5, 2024

(54) INTELLIGENT VALVE CONNECTIING TO INTERNET

(71) Applicant: YUHUAN DONGHAI VALVE CO.,LTD, Taizhou (CN)

(72) Inventors: BINBIN ZHUO, Taizhou (CN); AIDA SHAO, Taizhou (CN)

(21) Appl. No.: 18/670,562

(22) Filed: May 21, 2024

(30) Foreign Application Priority Data
Jun. 1, 2023 (CN) 202321381705.3

(51) Int. Cl. F16K 31/08

(52) U.S. Cl. CPC F16K 31/082

(57) ABSTRACT

An intelligent valve that connects to internet is provided, which includes a main control module, a 4G/5G module, a touch screen, a Wi-Fi module, a sensor module, a relay module and an electromagnetic valve body. The main control module is respectively connected with the 4G/5G module, touch screen, Wi-Fi module, sensor module and relay module. The relay module is connected to the electromagnetic valve body. The 4G/5G module communicates with a cloud server through a base station, the Wi-Fi module communicates with the cloud server by connecting the internet through a wireless router; a 32-bit microcontroller STM32F103VET6 is used in the main control module as a main control chip. The main control chip on the main control module has 100 pins, and 70-80 pins are configured to be universal IO ports to control a plurality of electromagnetic valve bodies, thus an effect of remote and close-range control is achieved.

### CROSS-REFERENCE TO RELATED APPLICATIONS

This application claims priority to Chinese Patent Application No. 202321381705.3, filed on Jun. 1, 2023, which is hereby incorporated by reference in its entirety.

### TECHNICAL FIELD

The present disclosure relates to the field of valve technologies, and in particular, to an intelligent valve that connects to internet.

### BACKGROUND

Electromagnetic valve is an electronic switching device that controls the opening and closing of various fluid (gas, liquid) pipelines. Its basic working principle is to use the magnetic field generated by coil to attract a valve body to achieve valve opening and closing control. It is currently widely used in industries such as general industry, weapons industry, shipbuilding industry, and petrochemicals.

In recent years, with the development and popularization of agricultural Internet of Things technology, many devices in agricultural production needs to be electrified and networked. As an executing mechanism of the Internet of Things system, the use of electromagnetic valves is also rapidly increasing. From the current use situation, the existing electromagnetic valve control system mainly relies on manual control through a physical button on site, and some that can be remotely controlled lack on-site control, resulting in all valves being unusable when remote control fails.

From this, a technical problem that needs to be solved is: how to achieve more intelligent application of a valve, facilitates on-site or remote operation, and adapt to various use scenarios.

### SUMMARY

In view of the disadvantages of the prior art described above, a purpose of the present disclosure is to provide an intelligent valve that connects to internet, which has advantages of being able to carry out remote communication to achieve remote control, and can also carry out on-site local operation, thus saving energy and being efficient.

To achieve the above and other related purposes, the present disclosure adopts the following technical solution.

The present disclosure provides an intelligent valve that can connects to internet, including: a main control module, a 4G/5G module, a touch screen, a Wi-Fi module, a sensor module, a relay module and an electromagnetic valve body, where the main control module is respectively connected to the 4G/5G module, touch screen, Wi-Fi module, sensor module, and relay module, where the relay module is connected to the electromagnetic valve body, the 4G/5G module communicates with a cloud server through a base station, and the Wi-Fi module communicate with the cloud server by connecting the internet through a wireless router;
a 32-bit microcontroller STM32F103VET6 is used in the main control module as a main control chip, the main control chip on the main control module includes 100 pins, and 70-80 pins are configured to be universal IO ports to control a plurality of electromagnetic valve bodies.

In an embodiment, the electromagnetic valve body includes a valve body, a valve core mechanism, and a valve seat, the valve body is provided with a water inlet and a water outlet, the valve body is provided with an inner chamber, and the inner chamber is provided with a separator, the inner chamber is separated into a water inlet chamber and a water outlet chamber by the separator through the valve core mechanism, and the valve core mechanism is configured to open and close a communication between the water inlet chamber and water outlet chamber; where the valve core mechanism includes a drive rod, a piston head, and a diaphragm valve; the drive rod is thread connection to the valve seat, the valve seat fixes an edge of the diaphragm valve to an upper opening of the valve body, an inner ring of the diaphragm valve is fixed to a peripheral surface of the piston head, the piston head and the drive rod are rotationally connected and the piston head is controlled to lift and descend by the drive rod; the diaphragm valve is controlled to open or close the separator by lifting or descending of the piston head.

In an embodiment, the piston head and a movable rod are connected through a spring, the spring is sleeved on the drive rod, an upper end of the spring abuts against the valve seat, and a lower end of the spring abuts against the piston head.

In an embodiment, the piston head and the valve seat are provided with a clamp slot configured to clamp and fix the spring.

In an embodiment, an end of the drive rod is provided with a handle.

In an embodiment, a gear nut is provided at a thread of the drive rod, and the gear nut is rotationally installed on the valve seat, matched with the thread of the drive rod, and cooperates with a reducer.

In an embodiment, a water pressure sensor and a temperature sensor are provided at the water outlet of the valve body, the water pressure sensor is connected with a water pressure judgment module, the water pressure judgment module judges a smaller value of water pressure, and the temperature sensor is connected with a temperature judgment module, the temperature judgment module judges a smaller value of temperature, the water pressure judgment module and the temperature judgment module are respectively connected to a logic module, an output end of the logic module is connected with a temperature rise module, and the temperature rise module heats the valve body and/or valve seat.

Compared to the background technology, the technical effects of the present disclosure are mainly reflected in the following aspects:
(1) It can achieve a local control and a remote control, opening and closing of the valve is controlled, rendering it easy to use and maintain. When in use, the chip has an ARMCortexM3 core, running at a main frequency up to 72 MHz, with 64 kRAM and 512 kflash memory, so it can respond quickly enough to control the main body of a plurality of electromagnetic valves.
(2) The main structure of the electromagnetic valve can be disassembled and repaired, rendering it easy to replace the valve core mechanism or perform maintenance and repair on the valve core mechanism, thereby extending its service life.
(3) It can automatically control the temperature of the valve body and valve seat, so that automatic heating can be carried out in some low-temperature or cold northern regions to avoid jamming of the valve core mechanism operation.

### BRIEF DESCRIPTION OF DRAWINGS

The present disclosure will be further explained below in combination with the accompanying drawings and embodiments.

FIG. 1 shows a circuit module block diagram of an embodiment of the present disclosure.

FIG. 2 shows a structural schematic diagram of a valve body of an embodiment of the present disclosure.

FIG. 3 is a top view of FIG. 2.

FIG. 4 is a sectional view of FIG. 2.

FIG. 5 is a schematic diagram of a circuit in Embodiment 3.

FIG. 6 is a circuit diagram of Embodiment 3.

Numeral reference: 100. Main control module; 200, 4G/5G modules; 300. Touch screen; 400, Wi-Fi module; 500. Sensor module; 600. Relay module; 700. Electromagnetic valve body; 710. Valve body; 711. Water inlet; 712. Water outlet; 714. Separator; 715. Water inlet chamber; 716. Water outlet chamber; 720. Valve core mechanism; 721. Drive rod; 722, Piston head; 723. Diaphragm valve; 724. Spring; 725. Clamp slot; 726. Handle; 727. Gear nut; 730. Valve seat; 800, reducer; 900. Water pressure sensor; 901. Temperature sensor; 902. Water pressure judgment module; 903. Temperature judgment module; 904. Logic module; 905. Temperature rise module.

### DESCRIPTION OF EMBODIMENTS

The following specific examples will illustrate the embodiments of the present disclosure, and those skilled in the art can easily understand the other advantages and effects of the present disclosure from the content disclosed in this specification. The present disclosure can also be implemented or applied through different specific embodiments, and the details in this specification can be modified or changed based on different perspectives and applications without deviating from the spirit of the present disclosure. It should be noted that, without conflict, the following embodiments and their features can be combined with each other.

It should be noted that the illustrations provided in the following embodiments only illustrate the basic concept of the present disclosure in a schematic manner. Therefore, the illustrations only display components related to the present disclosure and are not drawn based on the number, shape, and size of the components in an actual implementation. The type, quantity, and proportion of each component in actual implementation can be arbitrarily changed, and the layout of its components may also be more complex.

The specific embodiments of the present disclosure will be further explained below in combination with the accompanying drawings.

### Embodiment 1

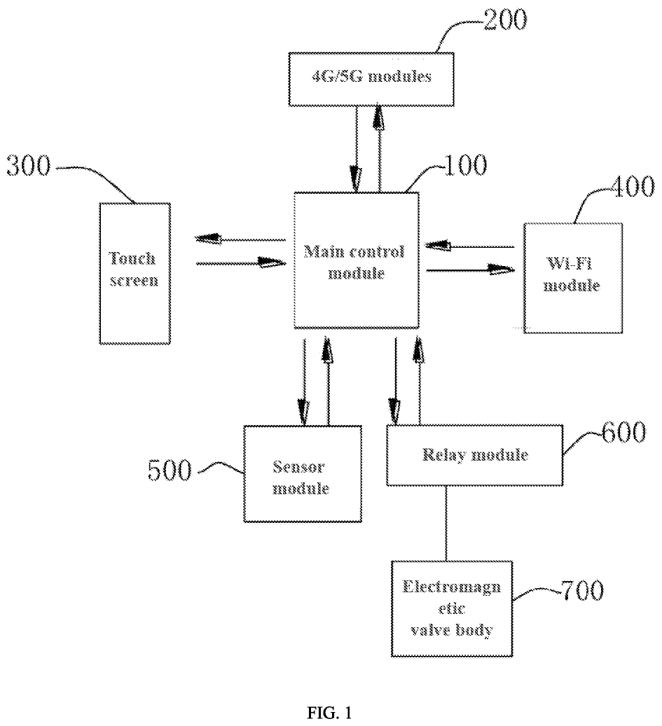

An intelligent valve that connects to internet, as shown in FIG. 1, includes a main control module 100, a 4G/5G module 200, a touch screen 300, a Wi-Fi module 400, a sensor module 500, a relay module 600, and an electromagnetic valve body 700. The main control module 100 is respectively connected to 4G/5G module 200, touch screen 300, Wi-Fi module 400, sensor module 500, and relay module 600. The relay module 600 is connected to the electromagnetic valve body 700, where the 4G/5G module 200 communicates with a cloud server through a base station, and the Wi-Fi module 400 communicates with the cloud server by connecting to the internet through a wireless router.

A 32-bit microcontroller STM32F103VET6 is used in the main control module 100 as a main control chip. The main control chip on the main control module 100 includes 100 pins, and 70-80 of pins are configured to be universal IO ports to control a plurality of electromagnetic valve bodies 700. This chip has an ARMCortexM3 core, running at a main frequency of up to 72 MHz, with 64 kRAM and 512 kflash memory, so it can respond quickly enough to control the multi way electromagnetic valve body 700. The most crucial thing is that it has four universal serial interfaces. The 4G/5G module is configured for remote transmission of sensor data. The touch screen 300 is configured for near-field control in operations. The sensor is configured to collect agricultural environmental parameters. The type of sensor can be selected according to a need, as long as it meets 485 interface and follows the Modbus RTU protocol. The Wi-Fi module is configured for remote control function. Internet connection can be realized to remotely control its opening, closing and operation.

### Embodiment 2

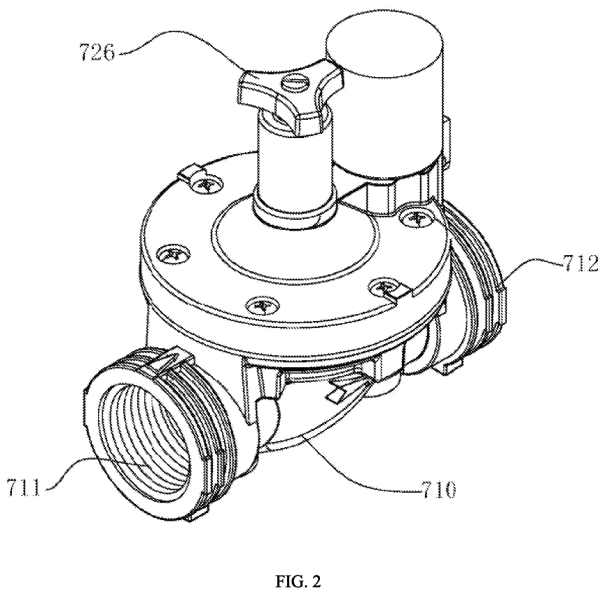

An intelligent valve that connects to Internet. Based on the intelligent hardware structure of Embodiment 1, the electromagnetic valve body 700 includes a valve body 710, a valve core mechanism 720, and a valve seat 730. Refer to FIGS. 2, 3, and 4; the valve body 710 is provided with a water inlet 711 and a water outlet 712. There is an inner chamber in the valve body 710, and a separator 714 is provided on the inner chamber. The inner chamber is separated into a water inlet chamber 715 and a water outlet chamber 716 by the separator 714 through the valve core mechanism 720.

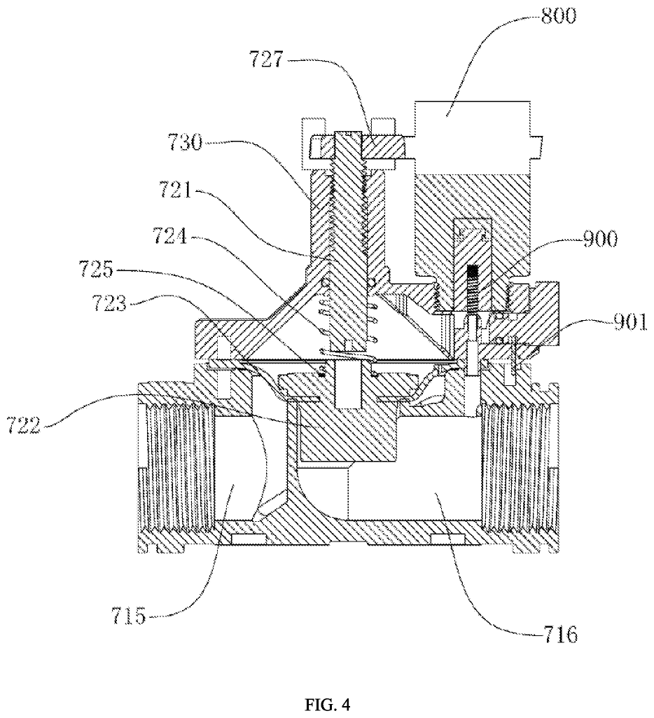

The valve core mechanism 720 is configured to open and close a communication between the water inlet chamber 715 and the water outlet chamber 716. The valve core mechanism 720 includes a drive rod 721, a piston head 722, and a diaphragm valve 723. An assembly of the valve body 710 and valve seat 730 is an upper-and-lower assembly, and they are fixed by a bolt. The drive rod 721 is vertically arranged and is thread connection to the valve seat 730. By rotating the drive rod 721, the drive rod can be lifted up and down on the valve seat 730, thereby achieving a movement of the piston head 722. The valve seat 730 fixes an edge of the diaphragm valve 723 to an upper opening of the valve body 710, an inner ring of the diaphragm is fixed on a circumferential surface of the piston head 722. The piston head 722 and the drive rod 721 are rotationally connected, and the piston head 722 is controlled to lift or descend by the drive rod 721. The diaphragm valve 723 is controlled to open or close the separator 714 by lifting or descending of the piston head 722. This can facilitate maintenance. The valve seat 730 can be removed from a top to remove the valve core mechanism 720. The connection assembly between piston head 722 and drive rod 721 can also be a ball joint (not shown in the figure). In an implementation, a method illustrated in FIG. 4 is used, the piston head 722 and a movable rod are connected by a spring 724, the spring 724 is sleeved onto the drive rod 721, an upper end of the spring 724 abuts against the valve seat 730, a lower end of the spring 724 abuts against the piston head 722. From this, it can be seen that when the drive rod 721 moves up and down, an upper end of the spring 724 is also clamped on the drive rod 721, the piston head 722 is caused to be pressed down or there is a downward force through spring 724, thus, the channel is obstructed.

A clamp slot 725 is provided on the piston head 722 and valve seat 730 for the spring 724 to be clamped and fixed. This can provide a more stable limit for spring 724.

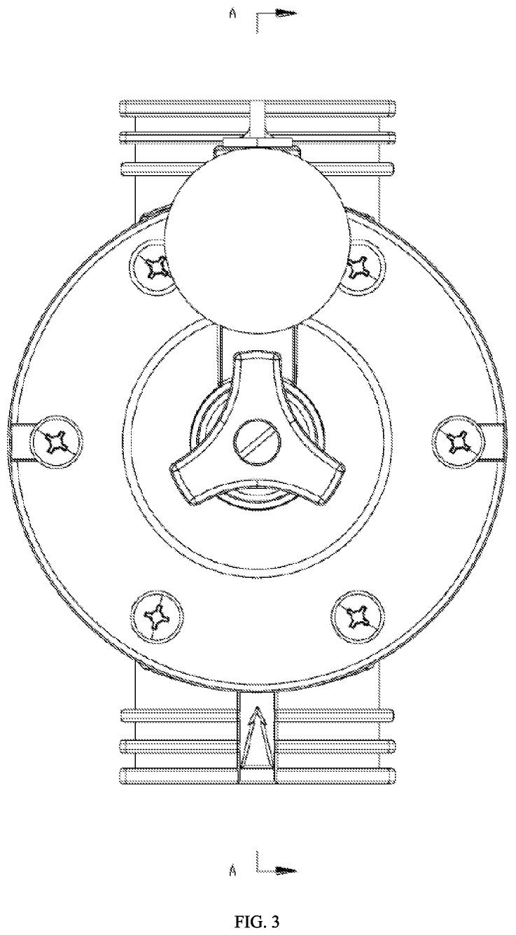

As can be seen in FIGS. 2 and 3, an end of the drive rod 721 is provided with a handle 726. The handle 726 is detachable and can be installed for manual operation to rotate and lift the drive rod 721.

If electric drive is required, a gear nut 727 is provided at a thread of the drive rod 721. The gear nut 727 is provided with a threaded hole on an inner side that fits with an external thread of the drive rod 721, that is, the principle of screw transmission. An outer side of gear nut 727 is a gear structure. The gear nut 727 is rotationally installed on the valve seat 730, is thread connection with the drive rod 721, and cooperates with a reducer 800. An output of the reducer 800 drives the gear nut 727 to rotate, thus the drive rod 721 is caused to move up and down.

For the control of the drive rod 721, other drivers can also be used to control the lifting or descending of the driven rod 27, such as a stepper motor, etc.

### Embodiment 3

An intelligent valve that connects to internet. In combination with FIGS. 4, 5 and 6, in an implementation, a water pressure sensor 900 and a temperature sensor 901 are provided at the water outlet 712 of the valve body 710, the water pressure sensor 900 is connected with a water pressure judgment module 902, the water pressure judgment module 902 judges a smaller value of the water pressure, the temperature sensor 901 is connected with a temperature judgment module 903, the temperature judgment module 903 judges a smaller value of temperature, the water pressure judgment module 902 and the temperature judgment module 903 are respectively connected to a logic module 904, an output end of the logic module 904 is connected with a temperature rise module 905, and the temperature rise module 905 heats the valve body 710 and/or the valve seat 730. The water pressure judgment module 902 is a comparator module that has a set minimum water pressure value, and outputs a high level when the water pressure is less than the minimum water pressure value. Similarly, the temperature judgment module 903 is also a comparator module with a set minimum temperature value. When a current temperature is less than the minimum temperature value, it outputs a high level. The logic module 904 is an AND gate circuit, which outputs a high level when both inputs are high level. From this, it can be seen that when the temperature is below the set minimum value and the water pressure is below the set minimum value, the logic module 904 outputs a high level, which causes the temperature rise module 905 to start working. The temperature rise module 905 is an electric heating wire device controlled by an electronic switch. The electric heating wire is wrapped around the valve body 710 or valve seat 730 through a thermal insulation fabric, especially for thermal insulation of the valve core mechanism 720 to avoid jamming. The external temperature is resisted through thermal conduction and radiation. Its power supply is all powered by a lithium battery pack, which can be plugged and replaced at any time to maintain a continuous power supply.

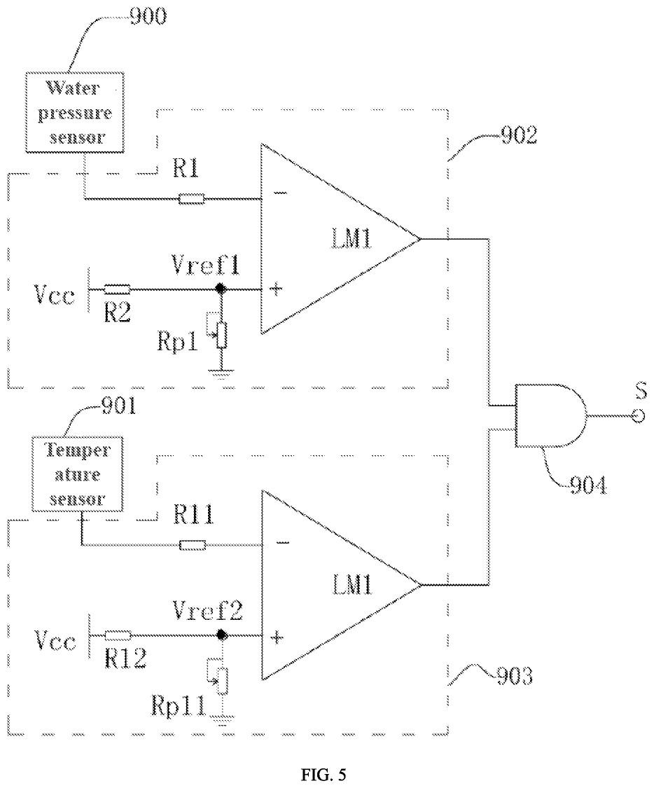

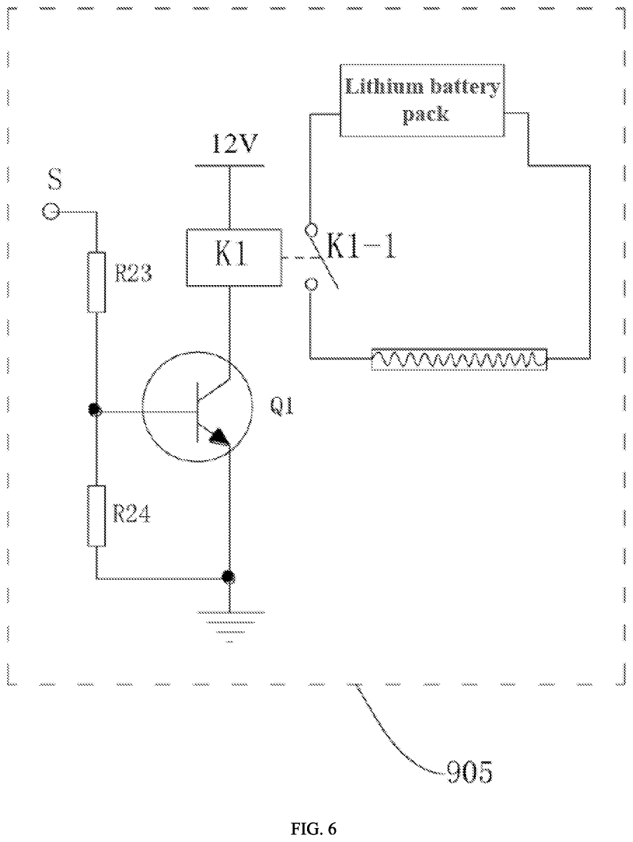

Specifically, in FIGS. 5 and 6, the water pressure comparison module is taken as an example, it includes a resistor R1, a comparator LM1, a reference circuit providing the set value of Vref1, and the current water pressure signal is output by the water pressure sensor 900. By comparing it with the set minimum water pressure value, when it is lower than the set value, the comparator LM1 outputs a high level, which similarly shows the temperature judgment method. The temperature rise module module 905 is an electronic switch circuit composed of resistors R23, R24, transistor Q1, and relay K1. When the logic module 904 outputs a high-level signal S, signal S controls a conduction of the transistor Q1, thereby energizing the relay K1, the lithium battery pack is caused to start heating the heating wire. Due to a constant output current of the lithium battery pack, the heating remains constant. Then, the electric heating wire is wrapped or adhered to the valve body 710 through the thermal insulation fabric.

The above embodiments are only illustrative of the principle and efficacy of the present disclosure, and are not intended to limit the present disclosure. Anyone familiar with this technology may modify or substitute the above embodiments without violating the spirit and scope of the present disclosure. Therefore, all equivalent modifications or changes completed by those skilled in the art without departing from the spirit and technical ideas disclosed in the present disclosure should still be covered by the claims of the present disclosure.

What is claimed is:

1. An intelligent valve that connects to internet, comprising:
a main control module, a 4G/5G module, a touch screen, a Wi-Fi module, a sensor module, a relay module and an electromagnetic valve body, wherein the main control module is respectively connected to the 4G/5G module, touch screen, Wi-Fi module, sensor module, and relay module, wherein the relay module is connected to the electromagnetic valve body, the 4G/5G module communicates with a cloud server through a base station, and the Wi-Fi module communicate with the cloud server by connecting the internet through a wireless router;
a 32-bit microcontroller STM32F103VET6 is used in the main control module as a main control chip, the main control chip on the main control module comprises 100 pins, and 70-80 pins are configured to be universal IO ports to control a plurality of electromagnetic valve bodies.

2. The intelligent valve that connects to internet according to claim 1, wherein the electromagnetic valve body comprises a valve body, a valve core mechanism, and a valve seat, the valve body is provided with a water inlet and a water outlet, the valve body is provided with an inner chamber, and the inner chamber is provided with a separator, the inner chamber is separated into a water inlet chamber and a water outlet chamber by the separator through the valve core mechanism, and the valve core mechanism is configured to open and close a communication between the water inlet chamber and water outlet chamber; wherein the valve core mechanism comprises a drive rod, a piston head, and a diaphragm valve; the drive rod is thread connection to the valve seat, the valve seat fixes an edge of the diaphragm valve to an upper opening of the valve body, an inner ring of the diaphragm valve is fixed to a peripheral surface of the piston head, the piston head and the drive rod are rotationally connected and the piston head is controlled to lift and descend by the drive rod; the diaphragm valve is controlled to open or close the separator by lifting or descending of the piston head.

3. The intelligent valve that connects to internet according to claim 2, wherein the piston head and a movable rod are connected through a spring, the spring is sleeved on the drive rod, an upper end of the spring abuts against the valve seat, and a lower end of the spring abuts against the piston head.

4. The intelligent valve that connects to internet according to claim 3, wherein the piston head and the valve seat are provided with a clamp slot configured to clamp and fix the spring.

5. The intelligent valve that connects to internet according to claim 2, wherein an end of the drive rod is provided with a handle.

6. The intelligent valve that connects to internet according to claim 2, wherein a gear nut is provided at a thread of the drive rod, and the gear nut is rotationally installed on the valve seat, matched with the thread of the drive rod, and cooperates with a reducer.

7. The intelligent valve that connects to internet according to claim 6, wherein a water pressure sensor and a temperature sensor are provided at the water outlet of the valve body, the water pressure sensor is connected with a water pressure judgment module, the water pressure judgment module judges a smaller value of water pressure, and the temperature sensor is connected with a temperature judgment module, the temperature judgment module judges a smaller value of temperature, the water pressure judgment module and the temperature judgment module are respectively connected to a logic module, an output end of the logic module is connected with a temperature rise module, and the temperature rise module heats the valve body and/or valve seat.
